(19) United States
(12) Patent Application Publication
(10) Pub. No.: US 2005/0114640 A1
(43) Pub. Date: May 26, 2005

(54) Method and system for efficiently binding a customer order with a processing system assembly in a manufacturing environment

(75) Inventors: Eric E. Blouin, Ardmore, PA (US); Barry A. Kritt, Raleigh, NC (US); Douglas A. Law, Chapel Hill, NC (US); Charles H. Meriwether, Chapel Hill, NC (US); Paul A. Roberts, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/716,161

(22) Filed: Nov. 17, 2003

(51) Int. Cl. G06F 9/24

(52) U.S. Cl. 713/1

(57) ABSTRACT

Aspects for efficiently assembling a processing system in a manufacturing environment are described. The aspects include enabling a network boot option for boot packet transfers in a system under test (SUT) during a manufacturing line assembly process and utilizing data from network packet transfers by the SUT to perform binding operations for the SUT. The binding operations include an initial binding based on boot request packet data by a floor system server and an order-specific information recall based on network packet data by a local control machine.

### RELATED APPLICATIONS

The present invention is related to co-pending U.S. patent applications, entitled METHOD AND SYSTEM FOR EFFICIENT ORDER PROCESSING IN A MANUFACTURING ENVIRONMENT, Ser. No. ______ (RPS920030195US1), and METHOD AND SYSTEM FOR ALLOWING A SYSTEM UNDER TEST (SUT) TO BOOT A PLURALITY OF OPERATING SYSTEMS WITHOUT A NEED FOR LOCAL MEDIA, Ser. No. ______ (RPS920030169US1), filed on even date herewith, and assigned to the assignee of the present invention.

### FIELD OF THE INVENTION

The present invention relates generally to processing systems and more particularly to a system and method for efficiently binding a customer order with a processing system assembly in a manufacturing environment.

### BACKGROUND OF THE INVENTION

During a box line manufacturing process of computer systems, the first step an operator performs is to assemble a unit (hereafter called a system under test, or SUT) from a kit of parts. This is normally done in a unique physical area known as “Assembly”. Once this assembly is completed, an initial problem arises when trying to associate this new SUT with its order, which at this point is only known to a floor control system. Another problem is maintaining this association across SUT reboots and when the SUT is physically routed to an indeterminate location as required by the layout of manufacturing line. For example, a manufacturing line layout may dictate that there are many separate areas, including an assembly area, an attended test area, an unattended test area, a hi-pot (high potential) testing area, and a debug area.

In order for the association of an SUT with its order to occur, there must be a “binding” operation such that the servers that control the manufacturing process understand which order corresponds to a given SUT. This binding operation applies to the first event that initiates the creation of a unique machine-type-serial-number “MTSN” directory for that specific SUT. This MTSN directory is created on a manufacturing server and contains, among other data, the process state file which is built based on the specifics of the customer's order. This binding operation also applies to maintaining the relationship between a specific SUT and its corresponding MTSN directory across SUT reboots and physical movements. If this MTSN relationship is lost, an SUT will start over every time it is rebooted or moved to a new location.

One possible solution to binding an SUT is to use a wired or wireless scanner at each manufacturing server to identify when an SUT with a MSTN has entered or exited a bar-coded physical location. The drawback to this solution is the procurement and maintenance costs of wired or wireless scanners and the complications that occur when the SUT is comprised of multiple scanned parts all present at the same physical location.

Another solution is to perform all manufacturing operations at a single location. However, this approach fails to take into account other requirements for manufacturing line architecture, such as work flow management, optimizing throughput, and accommodating different levels of operators for different operations. For example, a well trained and experienced operator may be able to successfully handle a debug area, while plugging cables to initiate testing and software preloads in the unattended area may be done by a less experienced or lower skilled operator. In addition, confining the SUT to a single location only eliminates the binding operation for the physical movement event. It does not address binding during the creation of the MTSN directory or after the SUT is rebooted.

Accordingly, a need exists for a low cost and effective approach to bind an SUT to order-specific information in a box line manufacturing process. The present invention addresses such a need.

### SUMMARY OF THE INVENTION

Aspects for efficiently binding a customer order with a processing system assembly in a manufacturing environment are described. The aspects include utilizing data network packet transfers by the SUT to perform binding operations for the SUT. The binding operations include an initial binding based on network packet data by a floor system server and an order-specific information recall based on network packet data by a local control machine. The preferred type of network packet for obtaining binding information is the broadcast packet used for SUT network booting or for requesting a network address.

Through the present invention, binding can occur without the need and associated procurement and maintenance costs of wired or wireless scanners. Further, the present invention binding processes allow manufacturing line architecture flexibility by permitting an SUT to be physically routed to an indeterminate location as necessary and as defined by the user (via the floor control system). In addition, once an SUT starts to transmit packets on the network at a new location, these packets can be intercepted, analyzed for binding information and the binding information can be used to start order-specific programs. These and other advantages of the present invention will be more fully understood in conjunction with the following detailed description and accompanying drawings.

### BRIEF DESCRIPTION OF THE DRAWINGS

FIG. 1 illustrates a system diagram of a manufacturing environment for order binding in accordance with a preferred embodiment of the present invention.

FIG. 2 illustrates a block flow diagram of an initial binding method in accordance with a preferred embodiment of the present invention.

FIG. 3 illustrates a block flow diagram of an order-specific information recall method in accordance with a preferred embodiment of the present invention.

### DETAILED DESCRIPTION

The present invention relates generally to processing systems and more particularly to a system and method for order binding in a manufacturing environment. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

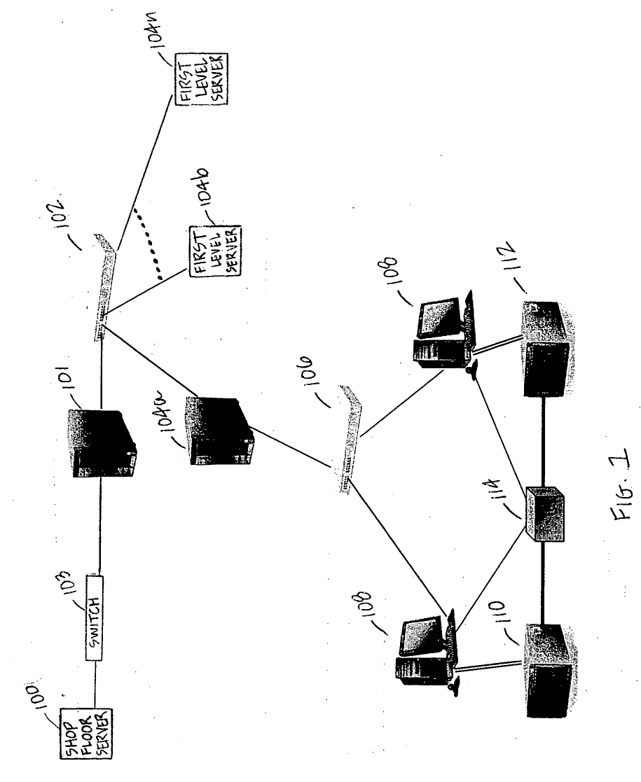

FIG. 1 illustrates a system diagram of a manufacturing environment for processing system assembly in accordance with a preferred embodiment of the present invention. Included is a shop floor system server 100 coupled via a network switch, e.g., an Ethernet switch 103, to a second level server 101. The second level server is coupled to a plurality of first level servers 104a-104n via switch 102. Another network/Ethernet switch 106 couples the first level server 104 to local control stations 108, such as an X3 station available from IBM Corporation, Armonk, N.Y. The local control stations 108 are each coupled to a system under test (SUT) 110, 112. A power cycler 114 is also coupled to the local control stations 108 and SUTs 110, 112.

It should be appreciated that although a single first level server is represented in FIG. 1, multiple first level servers may be utilized, each first level server networked to the shop floor system server and supporting a networked connection to other arrangements of local control stations and SUTs.

In operation, the shop floor system server 100 passes customer orders to the second level server 101 and launches server-side code to perform an initial binding process in accordance with the present invention, as described in more detail hereinbelow. Preferably, the present invention is implemented as a software service on a suitable computer readable medium that runs on a manufacturing server or floor control station with an SUT having its network boot option enabled. When the SUT is powered on, the firmware associated with the network boot issues DHCP/bootp packets which is looked for by the server-side binding code.

The first level server 104 contains the MTSN directories. The MTSN directory contains, among other data, the process state file which is built based on the specifics of the customer's order. The local control stations 108 run code to perform order-specific information recall in accordance with a preferred embodiment of the present invention, as described in more detail hereinbelow. In performing the order-specific information recall, the local control stations 108 launch a sequencer based on the process definition file in the MTSN directory for a given SUT. The SUTs 110, 112 run the majority of the operations.

Initial Binding

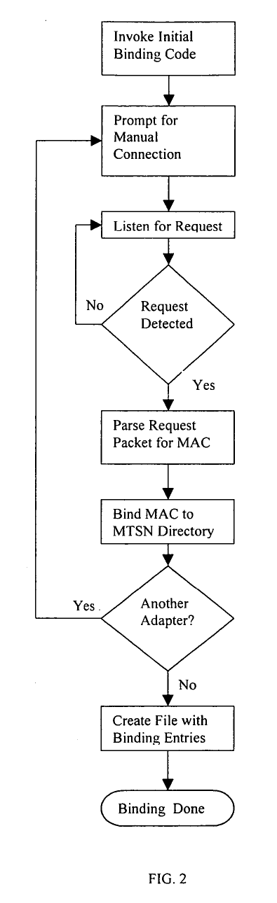

Referring now to FIG. 2, a block flow diagram illustrates an initial binding method in accordance with a preferred embodiment of the present invention. The initial binding initiates with the invocation of the server-side code by the shop floor system server 100 during assembly, and the passing of the MTSN directory name as a parameter to the server-side code (step 200). The binding process continues by prompting the operator of the shop floor system server 100 to make the proper network connection (in manual mode) between the shop floor system server 100 and the SUT 110 or 112 (step 202). The server-side code establishes a socket to UDP port 67, the DHCP Server/bootp port (step 204), the techniques for which are well understood in the art. The server-side code then listens on that socket for DHCP/bootp requests (step 204).

When a request has been detected (via step 206), the server-side code parses the next request packet received to extract the MAC address of the SUT (step 208). The server-side code then binds the MAC address and the MTSN directory name (step 210). The server-side code repeats the binding for each network adapter for SUTs having multiple network adapters (via step 212), i.e., it collects ‘n’ MAC addresses where ‘n’ is the number of network adapters in the SUT. The server-side code creates a file with a binding entry for each MAC address found (step 214) and then terminates. The file with the binding entry is now available for other process code to obtain the binding information.

Order-Specific Information Recall

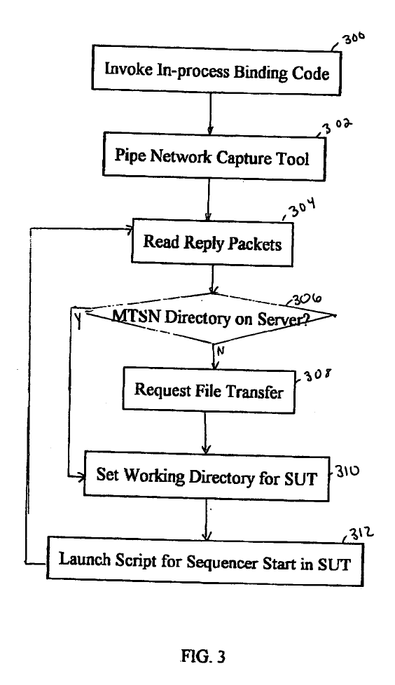

With the initial binding completed, the present invention includes a method for order-specific information recall, as described with reference to the flow diagram of FIG. 3. The order-specific information recall code is invoked on the local control station 108. A network packet capture tool is run on the local control station 108 and its output is redirected/piped into the order-specific information recall code (step 302). A loop is then started and runs continuously in the local control station 108. Within the loop is a step to read DHCP/bootp reply packets from the SUT to get both the MAC and IP data from the packet (step 304).

When a determination is made that the MTSN directory corresponding to the MAC data that has been read is not already on the first level server 104 (via step 306), a transfer request for the MTSN directory data is initiated by the creation of a request file (step 308). The utilization of a request file is based on pre-existing functionality available in the local control system, the details of which are included in co-pending U.S. patent application entitled METHOD AND SYSTEM TO PROVIDE A BOOT IMAGE TO A PROCESSING UNIT THAT DOES NOT INCLUDE STORAGE MEDIUM, Ser. No. 10/248,618, assigned to the assignee of the present invention and incorporated herein by reference in its entirety.

Once the transfer request has been completed or when the MTSN directory is already on the first level server 104 (step 310), the order-specific information recall code sets the working directory for the SUT to be its MTSN directory (step 312). The MTSN directory contains, among other data, the process state file which is built based on the specifics of the customer's order. The order-specific information recall code then launches the start-up script for the SUT to get a sequencer started (step 314). The sequencer is a tool that controls the execution of tasks on the SUT, the details of which are included in co-pending U.S. patent application entitled METHOD AND SYSTEM FOR EFFICIENT ORDER PROCESSING IN A MANUFACTURING ENVIRONMENT, Ser. No. ______ (RPS920030195US1), assigned to the assignee of the present invention and incorporated herein by reference in its entirety.

If the SUT is rebooted or physically moved, the order-specific information recall process returns to step 304. For a reboot situation, the MTSN directory will be already present on the first level server. However, for the physical moving of the SUT, the MTSN directory transfer request may be necessary, since the moving of the SUT may be to a portion of the manufacturing line under a different first level server.

In this manner, in the present invention, an initial binding is performed by extracting data from bootp request packets received from the SUT. An order-specific information recall is similar, but it uses bootp reply packets to receive its data. The order-specific information recall code also gets the process started for the SUT by initiating the sequencer. The sequencer is the tool that controls the execution of tasks on the SUT. Thus, the present invention defines a low-cost business method to perform binding of an SUT with its order.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for efficiently assembling a processing system in a manufacturing environment, the method comprising:
enabling a network boot option for boot packet transfers in a system under test (SUT) during a manufacturing line assembly process; and
utilizing data from boot packet transfers by the SUT to perform binding operations for the SUT.

2. The method of claim 1 wherein the step of utilizing further comprises performing an initial binding based on boot request packet data.

3. The method of claim 2 further comprising performing the initial binding with a floor system server.

4. The method of claim 3 wherein performing the initial binding further comprises:
making a network connection manually between the floor system server and the SUT;
parsing a next boot request packet received to extract a MAC address of the SUT; and
binding the MAC address and an MTSN (machine-type-serial-number) directory name.

5. The method of claim 4 further comprising repeating the initial binding for each network adapter in the SUT.

6. The method of claim 4 further comprising creating a file with a binding entry for the MAC address

7. The method of claim 1 wherein the step of utilizing further comprises performing an in-process binding based on boot reply packet data.

8. The method of claim 7 further comprising performing the in-process binding with a local control machine.

9. The method of claim 8 wherein performing the in-process binding further comprises:
reading the boot reply packet data from the SUT to get MAC and IP data;
transferring an MTSN (machine-type-serial-number) directory corresponding to the MAC data to a local server when the MTSN directory is not already on the local server;
setting a working directory for the SUT to be the MTSN directory; and
launching a start-up script for the SUT to get a sequencer started.

10. The method of claim 9 further comprising performing the in-process binding continuously on the local control machine.

11. A system for efficiently assembling a processing system in a manufacturing environment, the system comprising:
a system under test (SUT), the SUT having an enabled network boot option;
a floor system server networked to the SUT, the floor system server performing an initial binding for the SUT based on boot request packet data of the SUT; and
a local control system coupled to the SUT and networked to the floor system server, the local control system performing an in-process binding for the SUT based on boot reply packet data of the SUT, wherein the SUT is efficiently bound to an order.

12. The system of claim 11 wherein the floor system server further parses a boot request packet to extract a MAC address of the SUT, and binds the MAC address and an MTSN (machine-type-serial-number) directory name.

13. The system of claim 12 wherein the floor system server creates a file with a binding entry for the MAC address

14. The system of claim 12 wherein the floor system server repeats the initial binding for each network adapter in the SUT.

15. The system of claim 11 wherein the local control system reads the boot reply packet data from the SUT to get MAC and IP data, transfers an MTSN (machine-type-serial-number) directory corresponding to the MAC data to a local server when the MTSN directory is not already on the local server, sets a working directory for the SUT to be the MTSN directory, and launches a start-up script for the SUT to get a sequencer started.

16. The system of claim 15 wherein the local control system performs the in-process binding continuously.

17. Computer readable medium containing program instruction for binding a processing system to an order in a manufacturing environment, the program instructions comprising:
performing an initial binding of a system under test (SUT) by a floor server system; and
performing an in-process binding of the SUT by a local control station.

18. The computer readable medium of claim 17 wherein performing an initial binding occurs based on boot request packet data of the SUT and performing an in-process binding occurs based on boot reply packet data of the SUT.

19. The computer readable medium of claim 17 wherein performing an initial binding further comprises parsing a boot request packet to extract a MAC address of the SUT, and binding the MAC address and an MTSN (machine-type-serial-number) directory name.

20. The computer readable medium of claim 17 wherein performing an in-process binding further comprises reading boot reply packet data from the SUT to get MAC and IP data, transferring an MTSN (machine-type-serial-number) directory corresponding to the MAC data to a local server when the MTSN directory is not already on the local server, setting a working directory for the SUT to be the MTSN directory, and launching a start-up script for the SUT to get a sequencer started.
